(19) United States
(12) Patent Application Publication
(10) Pub. No.: US 2007/0184080 A1
(43) Pub. Date: Aug. 9, 2007

(54) Post harvest treatment of crops

(75) Inventor: Vernon P. KEATING, Houston, TX (US)

Correspondence Address: James J Mullen;Attorney at Law, 8202 Compodolcino Drive, Corpus Christi, TX, 78414, US

(73) Assignee: AstraZeneca UK Ltd, London, ENG (GB)

(21) Appl. No.: 10/529,667

(22) PCT Filed: Oct. 7, 2003
(86) PCT No.: PCT/US03/31561

§ 371 Date: Nov. 13, 2005

Related U.S. Application Data
(60) Provisional application No. 60/420,511, filed on Oct. 23, 2002.

(51) Int. Cl. A01N 25/00

(52) U.S. Cl. 424/405

(57) ABSTRACT

Novel processes and combinations of matter for treating fresh produce to seal fresh-cut stems to reduce moisture loss and inhibit fungus, mold, rot and insect infestation at the site where the produce was separated from the plant stalk. Natural and commercially produced waxes are modified with elastomers to render efficacy for sealing produce at ambient and refrigerated temperatures, thus reducing moisture loss, reducing oxygen beneath the wax, and thus preventing infestation. The result is reduced loss of fresh produce due to moisture loss and infestation; and a safe, economical, and environmentally superior alternative to fungicides and biocides and brand enhancement opportunities in the general marketplace.

### FIELD OF THE INVENTION

The present invention relates to the post-harvest treatment of crops. More particularly, the invention relates to the application of modified waxes with specified characteristics to protect crops such as fruits and vegetables from biological infestations including pests, parasites, funguses, molds, rot, etc. The invention will be primarily described with references to its use on fruit such as bananas but it should be appreciated that the invention also has application with the treatment of infestation in other fruit, vegetables, ornamental plants, flowers, and other crops. At present the safe control of crown rot is a serious issue with the production of commercial bananas; the term “crown” refers to a bunch/group of bananas wherein the top of each banana comes together and are attached to a single stem.

### BACKGROUND OF THE INVENTION

Crops such as bananas, plantains, pineapples and artichokes often become biologically contaminated post-harvest. Contamination can be initiated pre-harvest (e.g. by parasitic presence at the time of picking/harvesting). During harvesting, (e.g. where contaminants are introduced by mechanical harvesting or human intervention) and post-harvest (e.g. where parasites or spores settle on post harvest product). Mold spores in the delatexing bath can be a source of spores during field packing of bananas.

Regardless of the time of contamination, it is desirable to treat harvested fruit, vegetables and plants prior to transport and storage to prevent damage from any such contamination. For example, international quarantine regulations and inspection require fruit to be free of live pests. To this extent, post harvest broad-spectrum pesticides and fungicides are currently applied to post-harvest produce, but there are international concerns with the residues of such chemicals on the fruit and vegetables so treated; especially the effects of such residues on humans.

A diverse number of fungi have been identified as key banana crown pathogens and include: Cephalosporium sp., Verticillium theobromae, Colletotrichum musae, Deightoneilla torulosa, Ceratocystis paradoxa, F. roseum semitectum and acrimoneum. The systemic fungicide Thiabenzadole is the most widely used chemical for the control of fungal infestation in commercial bananas. Controlled atmosphere vacuum bags where oxygen is removed at the time of packing is currently practiced for shipment of bananas to Western Europe. The practice is effective but with other drawbacks such as cost and other quality issues associated with this practice.

Even with the myriad of polymers, films, and other commercially available packaging substances, the fresh produce industry in general is primarily relying on biocides such as fungicides and pesticides as the commercial method to protect certain fresh-cut produce from fungus, mold, and insect infestation after harvest. There is growing market sentiment and even regional regulatory pressure on the produce industry to discontinue the use of biocides on fresh-picked fruit, vegetables and flowers. Certain fruit and vegetables such as bananas, plantains, artichokes, mangoes, nectarines, asparagus and pineapples are particularly susceptible to these infestations, with bananas being among the most susceptible to fungus and mold.

The damaged and cut surfaces resulting from the separation of the produce from the stalk (plant) release sap and moisture and form an ideal moist-medium for fungus, mold, and insect infestation. The biocide treatment protects the open surfaces until the cut on the fruit or vegetable naturally dries out over time to form a crust or natural barrier to infestation. Discontinuation of the use of biocides represents a serious economic challenge to the produce industry. For example, some industry estimates cite a thirty percent or higher loss of bananas if the freshly-cut banana stems (known as “crowns”) are not treated with biocides or otherwise effectively sealed shortly after the banana hands (clusters) are cut from the stalk. In some instances, adhesive tape and/or plastic bags have been used on a limited basis to protect banana crowns. Others use vacuum bags to reduce oxygen and thus retard fungal and mold growth. These practices are not particularly cost effective. Bananas emit a sticky latex material for approximately thirty minutes after the hands are cut from the stalk until the osmotic pressure is dissipated. The latex is an excellent growth medium for mold and fungi spores that cause crown rot, neck rot and pill rot. Bananas are water soaked for thirty minutes or so after cutting to dissipate the osmotic pressure, but latex production continues for some time thereafter. An effective post harvest methodology must effectively remove the latex and prevent oxygen sufficient to support fungal growth until the cut has had sufficient time to form a natural crust or barrier to infestation.

Various waxes have been evaluated as stem sealants however; some waxes become soft at elevated tropical ambient temperatures and lose their strength and/or become sticky. More important, however, is the inherent physical property of waxes to contract upon solidification and to become inelastic and brittle at the lower temperatures associated with refrigerated produce transport. Thus, typical wax coatings crack, when refrigerated losing efficacy as a protective barrier for preventing fungal infestation. In the field, especially in South America, produce is packaged at ambient temperatures sometimes approaching 100 degrees Fahrenheit. Produce is typically stored and shipped in refrigerated containers at temperatures of 40-50 degrees Fahrenheit. Contraction and insufficient elasticity of unmodified waxes during refrigeration is the primary reason that wax has not previously been found to be suitable for this purpose.

Three requirements must be met in finding an effective “barrier-alternative” to fungicide treatment: The barrier alternative must seal the stem without harming the produce (or crown skin in the case of bananas), and must retain sufficient flexibility (elasticity) under field conditions and retain sufficient flexibility under refrigerated transport and storage conditions so the barrier maintains an effective seal around the surface-of-application, thus conserving plant-moisture and preventing infestation. A commercially viable biocide alternative must also be simple enough for routine commercial application in remote field processing facilities and must be compatible with commercial packaging processes. The biocide alternative must be non-toxic and comply with regulatory guidelines for certain types of contact with food and meet regulatory guidelines for environmental stewardship.

The present invention described herein is particularly directed to the commercial processing and packaging of field produce to reduce moisture loss and prevent infestation of said produce. It is the strategy and practice of the combination of commercially available waxes with elastomeric wax-modifiers to produce a modified wax that delivers efficacy in the treatment of fresh produce stems. The present invention also includes application protocols and techniques for formulation and commercial field application.

Typical prior art references that have considered the pre or post harvest treatment of crops include the following references which are all incorporated herein by reference:

| U.S. PAT. NO. | | Title |
|---|---|---|
| 1. | 6,435,347 | Container for freshly harvested respiring, leafy produce |
| 2. | 6,379,731 | Methods for vacuum gas flush treatment of fresh produce |
| 3. | 6,287,617 | Gram negative antibacterial composition |
| 4. | 6,275,375 | Apparatus and methods of washing cores of cored lettuce heads |
| 5. | 6,196,237 | Methods of washing cores of cored lettuce heads |
| 6. | 6,189,299 | Apparatus for cooling and packing bulk fresh products |
| 7. | 5,908,649 | Package for perishable food and horticultural products |
| 8. | 5,863,584 | Method for treating produce and process water |
| 9. | 5,747,082 | Package for perishable food and horticultural products |
| 10. | 5,616,360 | Method for processing fresh melons |
| 11. | 5,505,950 | Method for packaging perishable food and horticultural products |
| 12. | 5,468,508 | Preservation of fresh fruit juices and fruit juice blends |
| 13. | 5,354,569 | Method of packing lettuce for storing and shipping |
| 14. | 5,316,778 | Method for processing leafy vegetables for extended storage |
| 15. | 5,290,580 | Cooling process for perishable food and horticultural products |
| 16. | 5,279,843 | Method for packing fresh vegetables with water |
| 17. | 5,200,219 | Method of preparing green beans and the resulting product |
| 18. | 5,151,284 | Method of preparing green beans and the resulting product |
| 19. | 5,097,755 | Method and apparatus for processing produce |
| 20. | 4,956,209 | Anti-fogging multilayered film and bag produced therefrom for |
| | | packing vegetables and fruits |
| 21. | 4,943,440 | Controlled atmosphere cut vegetable produce package and |
| | | method |
| 22. | 4,919,948 | Prolonging the shelf life of fresh root vegetables |
| 23. | 4,895,729 | Preservation of cut and segmented fresh fruit produce |
| 24. | 4,883,674 | Controlled atmosphere cut fruit package and method |
| 25. | 4,876,146 | Anti-fogging multilayered film and bag produced therefrom for |
| | | packaging vegetables and fruits |
| 26. | 4,867,996 | Method of preparing green beans |
| 27. | 4,855,153 | Prolonging the shelf life of fresh root vegetables |
| 28. | 4,834,554 | Plastic bag with integral venting structure |
| 29. | 4,810,512 | Stabilization of color of green vegetables |
| 30. | 4,808,420 | Fresh root vegetables with prolonged shelf life |
| 31. | 4,753,808 | Packaged pre-cut vegetables |
| 32. | 4,711,789 | Prolonging the shelf life of pre-cut fresh celery |
| 33. | 4,001,443 | Package and method for storing cut leafy vegetables |
| 34. | 6,030,927 | Post-harvest treatment of crops |
| 35. | 6,423,310 | Biological coating with a protective and curative effect for the |
| | | control of post-harvest decay |
| 36. | 5,863,584 | Method for treating produce and process water |
| 37. | 6,391,357 | Method for treating fresh produce |
| 38. | 6,045,844 | Method for the inhibition of fungal growth on fruits and veg. |
| 39. | 5,670,368 | Inhibiting plant pathogens with an antagonistic microorganism |
| 40. | 5,215,747 | Composition and method for protecting plants from |
| | | Phytopathogenic fungi |
| 41. | 6,372,238 B1 | Method of using implants to fertilize, control growth and fungal |
| | | and insect attack on bananas and fungi |

### DETAILED DESCRIPTION OF THE INVENTION

The novel formulation(s) useful for treating harvested crops, such as bananas and pineapples, comprise a mixture of (a) one or more waxes and (b) one or more elastomers, with the proviso that said formulation, after applied to said crop, will provide a substantially solid layer which exhibits elasticity and flexibility over a temperature range of from about 38 Degrees Fahrenheit to about 120 Degrees Fahrenheit and will be compatible with commercial packaging. Said layer will reduce moisture loss and reduce oxygen availability between the wax layer and the surface of the wax-treated produce.

The waxes used herein are any waxes that when combined with said elastomers will yield the desired characteristics which are suitable for achieving the desired end results. Such waxes include, without limitation, paraffin, microcrystalline, petrolatum, beeswax, Fischer-Tropsch, alpha olefin, polyethylene wax, and mixtures thereof.

The elastomers used herein are any elastomers that when combined with said waxes will yield the desired characteristics which are suitable for achieving the desired end results. Such elastomers include, without limitation, natural rubber, synthetic rubber (such as synthetic butyl rubber), ethylene vinyl acetate, atactic polypropylene, neoprene (or isoprene) and mixtures thereof.

The wax(es) in said formulation or mixture is present in the range of from about 10% by weight to about 99% by weight, based on the total weight of the mixture, preferably from about 20% to about 95%. This percentage range would also encompass a combination of waxes.

The elastomer(s) in said formulation or mixture is present in the range of from about 1% by weight to about 90% by weight based on the total weight of the mixture, preferably from about 1% to about 50%, and more preferably from about 1% to about 20%.

The present invention thus provides a novel combination o f waxes and wax-modifiers (elastomers) in formulations that render an effective seal or barrier when applied to the fresh-cut stems of various produce and flowers to reduce moisture loss and prevent infestation by mold, fungus, and insects. The actual formulation components suitable in this technique are varied if the components selected are combined to produce the desired elasticity and temperature performance. Specifically, different types and grades waxes have varying elasticity and tensile strength over a given range of temperature. Physical properties of waxes of diverse origin can be modified by combining said waxes with each other and one or more of a variety of elasticity modifiers to produce a formulation that is useful for the purposes described herein. The activities of processing, transportation, and storage of fresh-cut produce involves a wide temperature range. The selection of an effective wax formulation is based upon producing a compound that will affect a seal over the stem throughout these activities. Care must also be taken to select compatible wax wax-modifier combinations to avoid incompatibility that results in stratification in molten storage conditions or incompatibility with commercial packaging.

Additionally, this invention includes laboratory testing of the formulations to determine fitness for use and also includes methodology for field application in commercial produce processing facilities.

The present invention thus provides for novel processes for protecting fresh-cut produce and flower stems from fungus, mold and insect infestation by applying a thin layer of molten formulations of wax and elastomeric wax-modifiers to produce stems, thus creating a barrier that reduces water loss and prevents produce infestation. This method comprises:
1. a. Combining various types of waxes such as paraffin, microcrystalline, beeswax, petrolatum, Fischer-Tropsch, alpha olefin, or polyethylene wax with elastomers such as natural rubber(s), synthetic rubber(s), ethylene vinyl acetate, or atactic polypropylene (certain atactic polypropylenes with or without wax); for the purpose of delivering ambient and refrigerated formulation efficacy as a barrier film for the stalks of fresh-cut fruit, vegetables, and flowers to prevent infestation by fungus, mold, and insects.
   b. Formulation techniques and test methods for measuring efficacy of a specific wax and wax-modifier blend for the purpose(s) as described in item 1.(a.).
   c. Field application methodology for application of and commercial use of the formulation(s) as described in item 1.(a.).
2. Certain fruit and vegetable stems are highly susceptible to infestation by fungus, mold, rot and insects after harvest, causing significant waste and economic impact if not suitably protected from such infestation. Bananas and pineapples are particularly susceptible to such infestation. The formulation strategy and methodology described in item 1.(a) and item 3. can produce effective barrier films of modified wax to protect said produce stems.
3. Applying a molten layer of appropriately formulated wax and wax-modifiers to the freshly cut stem of a fruit, vegetable, or flower described in item 1.(a.) forms a barrier that protects the stem from infestation by fungus, mold, and insects, and reduces moisture loss at the stem.
4. Sealing the stems of certain produce and flowers with wax formulation films as described in item 1.(a.) and item 7. for the purpose of reducing moisture loss can extend shelf life and reduce spoilage of the sealed produce.
5. The efficacy of wax and/or wax formulations for the use(s) as described in item 2. is a function of the elasticity and flexibility of thin layers of a wax and/or wax formulation in both ambient conditions and refrigerated conditions, and the formulation's compatibility with commercial produce packaging materials.
6. Various formulations of commercially available waxes and wax-modifiers are suitable for use in formulations as described in item 2., provided, however, that the wax, wax-modifier formulation is sufficiently flexible and elastic at both ambient and refrigerated conditions to maintain an effective seal around the produce stem.
7. Various combinations of waxes and wax-modifiers can be created to adjust melting point, elasticity, tack, transparency (and/or opacity) of the barrier film as described in item 2.
8. Immersing the end of the fresh cut stem (or crown in the case of bananas) into molten formulations as described in item 1 (a.) or applying molten formulation and subsequently cooling the formulation until the resulting film solidifies creates an effective barrier film will deliver efficacy as described in item 2.
9. The selection of specific components for formulations described in item 1 (a.) and the relative proportions thereof are a function of formulation cost effectiveness and the degree of sealing that is required for any particular produce at any particular field-shipping conditions and for compatibility with any particular packaging materials.
10. Post-application solidification of the formulation film described in item 1 (a.) can be accelerated in the field by submerging the just-coated produce stem into a bath of water or another appropriate cooling medium such as a weak Sodium hypochlorite or trichloro-s-triazinetrione solution. This will accelerate hardening of the barrier coating and allow for immediate packing of the coated produce. The optional addition of a sanitizing agent in the water-bath serves as a preventative from buildup of bacteria or fungus in the water bath adding an additional measure of protection from produce infestation.
11. Brand enhancement and/or improved product image can be effected by the addition of appropriate dyes, pigments, and/or fragrances in the formulations described in item 1 (a.). In addition to customer appeal of the aesthetically enhanced presentation, advertising and brand enhancement opportunities exist in declarations that the produce contains no fungicides and/or is organically processed.
12. Natural fungicides such as citrus seed oil and/or Potassium alum can be added to the formulation as an added measure of protection from fungus infestation.

### EXAMPLES

### General

Formulation Methodology

The specific example(s) that follow comprise a simple but effective formulation methodology and efficacy-testing protocol to develop formulations for sealing fresh-cut banana crowns(stems). The same procedures and testing apply to other produce and flowers.

The wax(es) and elastomers are selected, weighed, melted, and mixed thoroughly. Additives such as pigments, dyes, and/or fragrances may be added. The melting point of the mixture is not critical, but for safety in handling and to prevent burning the banana stalk, melting points in the range of 170-190 Degrees Fahrenheit were used in this analysis. The mixture is heated to approximately 15-20 degrees above its melt point to produce a coating of approximately 0.125 inches in thickness.

A first pass screening test for efficacy is performed as follows: Pieces measuring approximately four inches by four inches of flexible paper or foil are prepared. Each experimental mixture (formulation) is poured in a thin film (approximately 0.125+/−inches in thickness) onto two pieces of the paper and allowed to form a uniform layer and solidify.

Each mixture is tested visually at 100 F for hardness and tensile strength by bending the sample and rubbing it with an instrument. The wax-layer should be sufficiently hard that it is not sticky or tacky, does not easily make impressions on the surface, does not flake and does not form strings when pulled apart.

Each mixture is tested visually at 45 F for elasticity by bending the paper and wax-layer approximately forty-five degrees around a pencil or other similar shaped instrument. If the formulation does not crack or break and it is sufficiently hard and not tacky at 100 F, it is further tested on actual banana crowns.

Fresh-cut banana crowns (or commercial banana crowns that are prepared by removing the crust that has formed over the surfaces where the crown was separated from the stalk.) are dipped into molten wax formulations that performed satisfactorily on the paper square. The bananas are coated approximately one inch below the crown to form a seal over the entire crown. The bananas are again observed at 100 F and 45 F. The formulation is evaluated to determine if strings of adhesive are formed when the banana crown is removed from the molten wax. Stringing negatively affects the visual appeal of the crown seal.

At 100 F the wax layer must be non-sticky or tacky, and possess sufficient strength not to tear easily when brushed. At 45 F the wax layer must not crack when the individual bananas are flexed at the wax coated connecting point where an individual banana connects to the crown. The wax must not adhere to the box or plastic liner-bag used in packaging the said produce.

Formulations that perform in these conditions are further tested on a sufficient number of bananas to ensure efficacy (e.g. Exhibit A). Pigments and dyes are added to the formulations for visual appeal. Natural and commercial insecticides and/or fungicides can be added into the formulation for slow release to deter infestation beyond the protection created by the wax seal. Natural oils, herbs, and essences can also be added to the wax formulation for slow release as desired.

The following are examples of actual formulations that have been tested for this purpose:

### Example 1

Microcrystalline wax with a melting point of 165 Degrees Fahrenheit was combined with butyl rubber in a weight ratio of 85 percent microcrystalline wax and 15 percent butyl rubber. The formulation performed satisfactorily during the paper testing and the banana testing (FIG. 1). There was no stringing. This formulation is suitable for the purposes described herein.

### Example 2

Microcrystalline wax with a melting point of 165 degrees Fahrenheit was combined with atactic polypropylene(APAO with a Brookfield Viscosity of 3500 and a Softening Point of 129 degrees Centigrade) in a weight ratio of 75 percent microcrystalline wax and 25 percent polypropylene. The formulation performed satisfactorily during the paper testing and the banana testing (FIG. 2). There was no stringing but the formulation was tacky at 100 F. The formulation was modified with the addition of 4 percent (wt) polyethylene wax. This formulation was retested and is suitable for the purposes described herein.

### Example 3

Alpha olefin wax with carbon atoms numbering thirty or more, was combined with atactic polypropylene (APAO with a Brooldield Viscosity of 3500 and a Softening Point of 129 degrees Centigrade) in a weight ratio of 75 percent wax and 25 percent polypropylene. The formulation did not perform satisfactorily as the formulation cracked on the banana stems due to shrinkage and insufficient elasticity during the 45 F testing (FIG. 3). The formulation was modified to weight 50 percent wax and 50 weight percent polypropylene. There was no stringing. The revised formulation performed satisfactorily at 45 F.

### Example 4

Alpha olefin waxes are quite opaque and microcrystalline wax and atactic polypropylene are somewhat transparent. A formulation with higher opacity was desired.

Alpha olefin wax with carbon atoms numbering thirty or more, was combined with microcrystalline wax and atactic polypropylene (APAO with a Brookfield Viscosity of 3500 and a Softening Point of 129 degrees Centigrade) in a weight ratio of 20 percent alpha olefin wax , 40 percent microcrystalline wax and 40 percent polypropylene. The formulation performed satisfactorily without stringing and is suitable for the purposes described herein. This formulation is more opaque than Example Formulation 1, which may be desirable in certain commercial applications.

### Example 5

An oxidized Fischer Tropsch wax with a congealing point of 187 degrees Fahrenheit and an acid value of 27 was combined with atactic polypropylene (APAO with a Brookfield Viscosity of 3500 and a Softening Point of 129 degrees Centigrade) in a weight ratio of 50 percent wax and 50 percent polypropylene. The formulation performed satisfactorily during the paper testing and the banana testing. There was no stringing. This formulation is suitable for the purposes described herein.

### Example 6

Microcrystalline wax with a softening point of 165 Degrees F., paraffin wax with a softening point of 120 Degrees F., and butyl rubber in a weight ratio of 45 percent microcrystalline wax, 45% paraffin wax, and 10% butyl rubber. The formulation performed satisfactorily during paper testing, banana testing, and in commercial field applications.

### Example 7

As set forth below, two sample formulations, Formula “C” and Formula “F”, containing paraffin wax, microcrystalline wax, and polybutylene (synthetic butyl rubber) were field tested in a tropical commercial banana operation. The test was designed to test the wax fungicide alternative, “the invention”, versus untreated placebo fruit and identical fruit treated with commercial fungicides. The inoculants were a highly concentrated aqueous Colletotrichum musae spore solution that is grossly more concentrated than actual field processing conditions. Formula “C” performed substantially better than the fungicide Thiabenzadole treated bananas in both infestation severity and incident rate.

This demonstration was performed with a commercial banana producer in a tropical field environment that is particularly susceptible to crown rot, neck rot and black spot infestations. The test methodology included with four main test groups, each containing a statistically significant number of banana hands (clusters) to compare the relative infestation incidence rate of:
a.) Untreated inoculated fruit.
b.) Modified-wax treated inoculated fruit.—Two Formulas, C and F
c.) Fungicide treated inoculated fruit.
1.) All of the fruit was inoculated with an aqueous suspension of 20,000 spores per milliliter of Colletotrichum by immersion in said suspension for a minimum of one minute.
2.) The Formula C and F wax treated fruit was processed by dipping the wet crown of the inoculated banana hands into the molten wax, cooling for one minute, and re-dipping in the molten wax.
3.) The Fungicide treated fruit was immersed into an aqueous solution of Thiabenzadole at the manufacturer's recommended dosage.
4. All of the fruit was packaged and stored in a laboratory warehouse for twenty-one days at a temperature of 14 Degrees C. and ninety percent relative humidity.

An empirical visual grading scale was employed to record and measure test results for a.) The presence or absence of rots and molds.; and b.) The severity of infestation. Latex staining was also observed and recorded. A visual infestation severity scale of one to five (1-5) was created where: 1=clean crown, and 5=severely rotten crown.

Latex staining of the fruit skin was recorded on an empirical visual scale where: 1=no staining whatsoever, and 3=the fruit is stained and unsuitable for market.

FORMULA (F)—A mixture of butyl rubber (12% by weight) and microcrystalline wax (88% by weight) with a softening point of approximately 190 Degrees Fahrenheit.

FORMULA (C)—A mixture of paraffin wax (55% by weight), microcrystalline wax (39% by weight), and butyl rubber (6%by weight) with a softening point of approximately 160 Degrees Fahrenheit

After incubation, the banana producer's trained laboratory technicians graded the fruit and the aggregate results were compiled as presented below.

Post-Harvest Treatment of Banana Crop Demonstration Results

| | | Severity | | | INCIDENCE | | | |
|---|---|---|---|---|---|---|---|---|
| | | Crown | Crown | | Crown | Crown | Neck | Peel |
| Treatment | Procedure | Mold | Rot | Latex | Mold | Rot | Rot | Rot |
| Scale | | 1-5 | 1-5 | 1-2 | Percent | Percent | Percent | Percent |
| Formula F | I | 3.75 | 4 | 1.05 | 92.2 | 100 | 7.83 | 18.77 |
| Formula F | ND | 2.17 | 2.25 | 2.37 | 73.45 | 100 | 0 | 4.7 |
| Formula C | I | 1.75 | 2.05 | 1.25 | 71.9 | 100 | 0 | 4.7 |
| Formula C | ND | 1.92 | 1.97 | 1.82 | 100 | 100 | 25 | 1.57 |
| Control | I | 5 | 4.97 | 1 | 100 | 100 | 72.2 | 92.27 |
| Control | I + T | 3.7 | 3.92 | 1.07 | 92.2 | 100 | 27.2 | 84 |
| Control | ND | | | 2.97 | | | | |

Legend: I = Inoculated, ND = no Delatexing, T = Thiabenzadole applied

Observations and Results

For prevention of mold and rot damage, the Formula C performed quite well. The inoculated Control was nearly 100% infested with the highest level of severity. The Formula C reduced incidence and severity of mold and rot by approximately 50% versus the analogous Thiabenzadole treated Control group. Formula F performed better than the Thiabenzadole treated Control group. There was no clear trend regarding the effect of the formulationsonLatexstaining.

Product Manufacturing and Packaging

Commercially produced modified wax as described herein is produced to specifications by melting the various components and mixing them with high-shear apparatus and/or stirred tanks. The modified wax can be shipped bulk molten in Isocontainers equipped with steam coils or electric resistance-heaters for reheating. The modified wax can also be shipped in the solid state in conventional drums, eleven-pound slabs or small pastilles for shipping and remelting at the use-destination.

Field Application

Actual field application procedures will vary with location, degree of automation and type of produce. In addition to the above Example 7, the following is an example of a manual field application procedure for bananas in tropical field locations.

The modified wax is melted on location in an insulated heated tank of sufficient size to deliver wax of sufficient quantity for an entire shift or for one day. The molten wax temperature is adjusted and maintained to deliver wax that will produce the desired thickness barrier-wax film (Typically this temperature is approximately 15-25 Degrees Fahrenheit above the melting point of the modified wax.)

Wax is drawn from the heated tank into smaller heated open-top containers that are sufficiently insulated and internally heated to maintain a relatively constant wax temperature.

Immediately prior to packing the produce, the produce stem (banana crown) is immersed into the molten wax to provide a wax film that is a minimum of one inch in length beyond the point where the bananas join together in the crown.

The treated wax crown is momentarily immersed into a bath of cooled or ambient water or placed on a conveyor and passed through a water curtain to solidify the wax seal (The water-bath step is optional but recommended.) The water bath may be treated with approximately 0.15-0.20 weight percent calcium hypochlorite or 2-3 parts-per-million (wt.) of trichloro-s-triazinetrione or other suitable oxidizing agent to reduce buildup of mold spores in the immersion water. The immersion water is replaced on a daily basis. The wax sealed banana hands are packed and shipped as per standard procedures.

In a more automated process, the molten wax is delivered to a dipping tank where the banana hand stems are immersed in the molten wax by a conveyor that carries the treated produce to the next step of processing.

Thus, the present invention provides novel processes and compositions along the following lines:
1. A post-harvest treatment method for the suppression of biological infestation in harvested crops comprising applying to the harvested crop a formulation comprising a mixture of (a) a wax and (b) an elastomer, with the proviso that said formulations after applied to dais crop, will provide a substantially solid sealing layer which exhibits elasticity and flexibility over a temperature range of from about 38 degrees Fahrenheit to about 120 degrees Fahrenheit. Said sealing layer reduces the incidence and severity of banana crown rot by sealing in moisture and reducing the amount of oxygen available to support fungal growth.
2. The process as set forth in item 1 wherein said waxes are selected from the group consisting of paraffin, microcrystalline, beeswax, Fischer-Tropsch, alpha olefin, polyethylene wax, and mixtures thereof.
3. The process set forth in item 1, whenever said elastomers are selected from the group consisting of natural rubber, synthetic rubber, ethylene vinyl acetate, atactic polypropylene, neoprene (isoprene), and mixtures thereof.
4. The process as set forth in item 1, wherein said waxes are present in said formulation in the range of from about 10% by weight to about 99% by weight based on the total weight of the formulation.
5. The process as set forth in item 1, wherein said elastomers are present in said formulation in the range of from about 1% by weight to about 90% by weight based on the total weight of the formulation.
6. The process as set forth in item 1, wherein the formulation is used for the post-harvest treatment of said crop is applied thereto by dipping or spraying said crop with the formulation.
7. The process as set forth in item 1, wherein said crop is a fruit, flower or vegetable.
8. The process as set forth in item 1, wherein said crop is a banana, plantain or pineapple.
9. The process as set forth in item 1 wherein said formulation is a mixture of paraffin and microcrystalline wax and synthetic rubber or a mixture of atactic polypropylene and paraffin and microcrystalline wax.
10. A composition of matter useful for treating harvested crops in order to reduce infestation thereof, which composes a mixture of (a) wax(es) and (b) elastomer(s), with the proviso that said mixture, after applied to said crop, will provide a substantially solid non-sticky barrier layer which exhibits elasticity and flexibility over a temperature range of from about 38 degrees Fahrenheit to about 120 degrees Fahrenheit.
11. The composition as set forth in item 10, wherein said waxes are selected from the group consisting of paraffin, microcrystalline, beeswax, Fischer-Tropsch, petrolatum, alpha olefin, polyethylene wax, and mixtures thereof.
12. The composition as set forth in item 10, wherein said elastomers are selected from the group consisting of natural rubber, synthetic rubber, ethylene vinyl acetate, atactic polypropylene, neoprene (isoprene), and mixtures thereof.
13. The composition as set forth in item 10, wherein said wax is present in said mixture in the range of from about 10% by weight to about 99% by weight based on the total weight of the formulation.
14. The composition as set forth in item 10, wherein said elastomers are present in said mixture in the range of from about 1% by weight to about 90% by weight, based on the total weight of the mixture.
15. The composition as set forth in item 10, wherein said mixture is paraffin and microcrystalline wax and butyl rubber or a mixture of microcrystalline wax, paraffin and atactic polypropylene.

What is claimed is:

1. A post-harvest treatment method for the suppression of biological infestation and subsequent rot in harvested crops comprising applying to the harvested crop a formulation comprising a mixture o f (a) a wax and (b) an e lastomer, with the proviso that said formulation after applied to at least a portion of said crop, will provide a substantially solid sealing layer which exhibits elasticity and flexibility over a temperature range of from about 38 degrees Fahrenheit to about 120 degrees Fahrenheit, and said sealing layer reduces the incidence and severity of rot by sealing in moisture and reducing the amount of oxygen available to support fungal growth.

2. The process as set forth in claim 1 wherein said wax is selected from the group consisting of paraffin, microcrystalline, beeswax, Fischer-Tropsch, alpha olefin, polyethylene wax, and mixtures thereof.

3. The process set forth in claim 1, whenever said elastomer is selected from the group consisting of natural rubber, synthetic rubber, ethylene vinyl acetate, atactic polypropylene, neoprene (isoprene), and mixtures thereof.

4. The process as set forth in claim 1, wherein said wax is present in said formulation in the range of from about 10% by weight to about 99% by weight based on the total weight of the formulation.

5. The process as set forth in claim 1, wherein said elastomer is present in said formulation in the range of from about 1% by weight to about 90% by weight based on the total weight of the formulation.

6. The process as set forth in claim 1, wherein the formulation is used for the post-harvest treatment of said crop and is applied thereto by dipping or spraying at least a portion of said crop with the formulation.

7. The process as set forth in claim 1, wherein said crop is a fruit, flower or vegetable.

8. The process as set forth in claim 1, wherein said crop is a banana, plantain or pineapple.

9. The process as set forth in claim 1 wherein said formulation is a mixture of paraffin and microcrystalline wax and synthetic rubber or a mixture of atactic polypropylene and paraffin and microcrystalline wax.

10. A composition of matter useful for treating harvested crops in order to reduce infestation thereof, which composes a mixture of (a) wax and (b) elastomer, with the proviso that said mixture, after applied to at least a portion of said crop, will provide a substantially solid, non-sticky barrier layer which exhibits elasticity and flexibility over a temperature range of from about 38 degrees Fahrenheit to about 120 degrees Fahrenheit.

11. The composition as set forth in claim 10, wherein said wax is selected from the group consisting of paraffin, microcrystalline, beeswax, Fischer-Tropsch, petrolatum, alpha olefin, polyethylene wax, and mixtures thereof.

12. The composition as set forth in claim 10, wherein said elastomer is selected from the group consisting of natural rubber, synthetic rubber, ethylene vinyl acetate, atactic polypropylene, neoprene (isoprene), and mixtures thereof.

13. The composition as set forth in claim 10, wherein said wax is present in said mixture in the range of from about 10% by weight to about 99% by weight based on the total weight of the mixture.

14. The composition as set forth in claim 10, wherein said elastomer is present in said mixture in the range of from about 1% by weight to about 90% by weight, based on the total weight of the mixture.

15. The composition as set forth in claim 10, wherein said mixture is paraffin and microcrystalline wax and butyl rubber or a mixture of microcrystalline wax, paraffin and atactic polypropylene.
